(19) United States
(12) Patent Application Publication
(10) Pub. No.: US 2021/0260675 A1
(43) Pub. Date: Aug. 26, 2021

(54) DRAWING DEVICE FOR DRAWING A TOOL

(71) Applicant: FIVES OTO S.P.A., 42022 BORETTO (REGGIO EMILIA) (IT)

(72) Inventors: ENRICO FORLANI, REGGIO EMILIA (IT); FRANCESCO LOLLI, REGGIO EMILIA (IT)

(21) Appl. No.: 17/178,981

(22) Filed: Feb. 18, 2021

(30) Foreign Application Priority Data
Feb. 21, 2020 (IT) 102020000003599

(51) Int. Cl. B23D 79/02; B23D 21/04

(52) U.S. Cl. CPC B23D 79/023; B23D 21/04

(57) ABSTRACT

Drawing device for drawing a tool (T), comprising: a support (2), provided with rests (21), structured to be slidably arranged in contact with an inner wall of a tube, and an attachment (22) for a tool (T); a cursor (3), movable along a longitudinal direction (Y) between at least a starting position and a return position; magnetic means (4), predisposed to magnetically constrain the support (2) and the cursor (3) with respect to the displacement along the longitudinal direction (Y).

The present invention relates to a drawing device for drawing a tool. In particular, but not exclusively, the invention is useful for drawing a tool inside a tubular profile or tube, for example in a profiling line. For example, the drawn tool is a container for collecting waste material produced by a cutting process.

The invention relates in particular, but not exclusively, to profiling lines for the production of welded tubular profiles. In substance, a profiling line allows a tubular profile to be produced starting from a steel strip which, in line, is progressively bent back about its own longitudinal axis until it assumes a tubular conformation. The longitudinal edges of the strip are alongside each other in the upper area of the profile. For this purpose a profiling line substantially comprises a series of bending units, arranged in succession, each of which comprises at least two profiling rollers. The progressive bending of the profile takes place by making the strip pass through the various bending units which, by contact, progressively deform it. The strip slides continuously through the bending units, being progressively deformed.

Still in line, i.e., while the profile advances continuously, the longitudinal edges are welded together. The profile is then cut into sections of predetermined length, by means of a cutting machine which operates on the moving profile. In a known manner, the cutting machine carries out a cycle of forward and return displacements. During the forward displacement, the cutting machine synchronises its advancement speed with the advancement speed of the profile and cuts it. After cutting, the cutting machine carries out a return stroke along which the profile is raised for a certain section, until it reverses its stroke again to carry out a forward stroke and newly cut the profile.

The whole production is performed in a continuous line, i.e., while the profile advances.

Some of the best-performing cutting machines use laser or plasma cutting heads. In such machines, the known art is to travel a trajectory parallel to the tube surface, thus cutting the thickness thereof. Alternatively, there are also solutions in which the tube translates intermittently, while the cutting machine remains in a fixed position.

As is known, the laser and plasma cutting produces a flow of waste material which is projected from the cutting edge on the inner side of the tube opposite to that on which the laser beam operates. In the case of cutting by a cutting machine, which operates outside the tube, the waste material accumulates on the inner surface of the tube, solidifying into an irregular layer.

Furthermore, in the case of cutting with multiple and opposite laser and plasma heads, there is the problem of blocking such a bundle of waste material and thus preventing it from damaging the opposite cutting head.

Very complex devices are currently used to prevent the accumulation of waste material, which require expensive and cumbersome mechanical systems and motors. Such systems are often inserted at a great distance from the cutting area, therefore their manoeuvrability is very limited and they do not allow a correct tracking of the bundle of waste material.

The object of the present invention is therefore to offer a drawing device for drawing a tool, suitable for handling a container for collecting a waste material and offering a shielding system, which allows to overcome the drawbacks of the devices currently available.

An advantage of the drawing device according to the present invention is to allow the tool to be drawn inside a tube in a precise and effective manner, minimising the required dimensions.

Another advantage of the drawing device according to the present invention is that it can be adapted to tubes of different shapes and sizes.

A further advantage of the drawing device according to the present invention is that of allowing the tool to rotate around an axis parallel to the drawing direction.

A further advantage of the drawing device according to the present invention is that it allows the longitudinal retention of the collection tool with respect to the cutting head without energy expenditure.

Additional features and advantages of the present invention will become more apparent from the following detailed description of one embodiment of the invention, illustrated by way of non-limiting example in the appended figures in which:

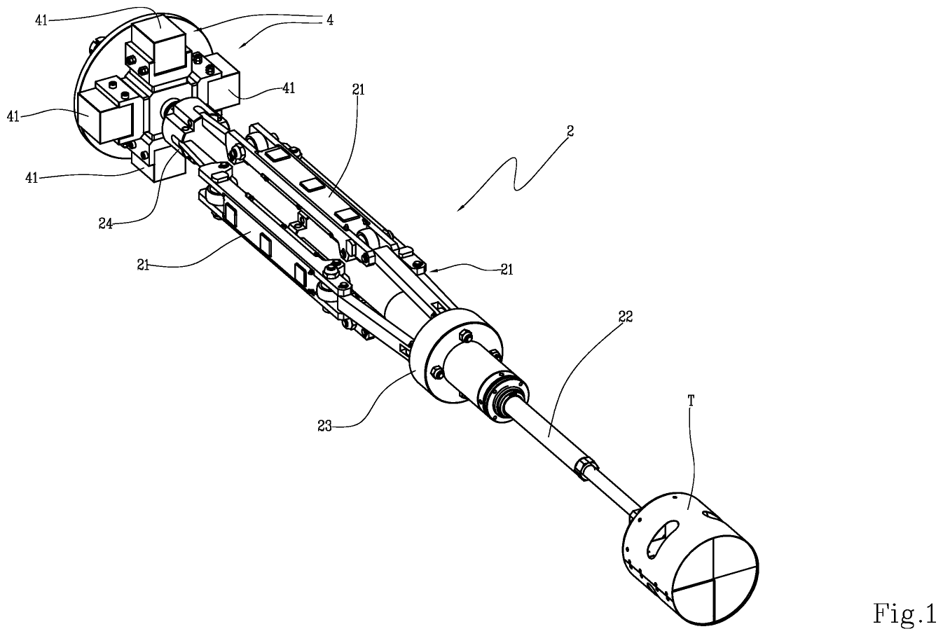

FIG. 1 shows an isometric view of a first component of the device according to the present invention;

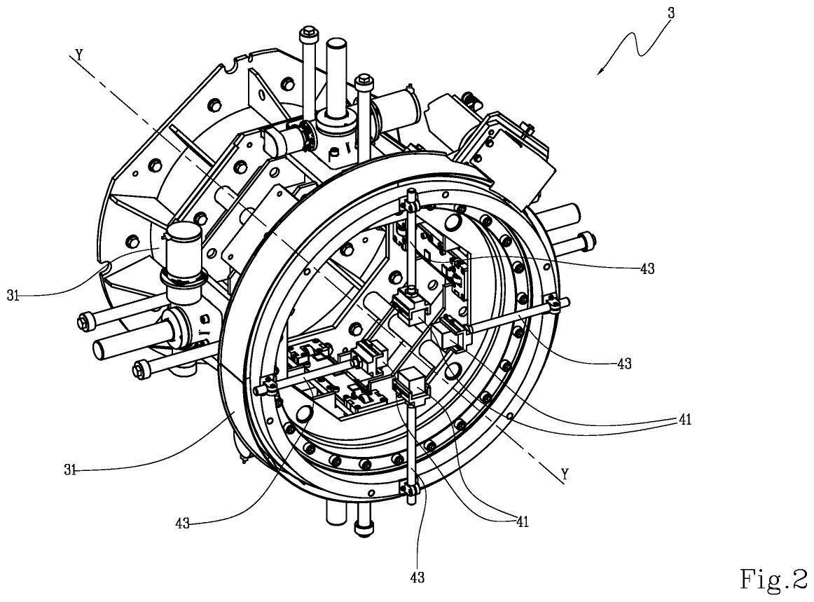

FIG. 2 shows an isometric view of a second component of the device according to the present invention;

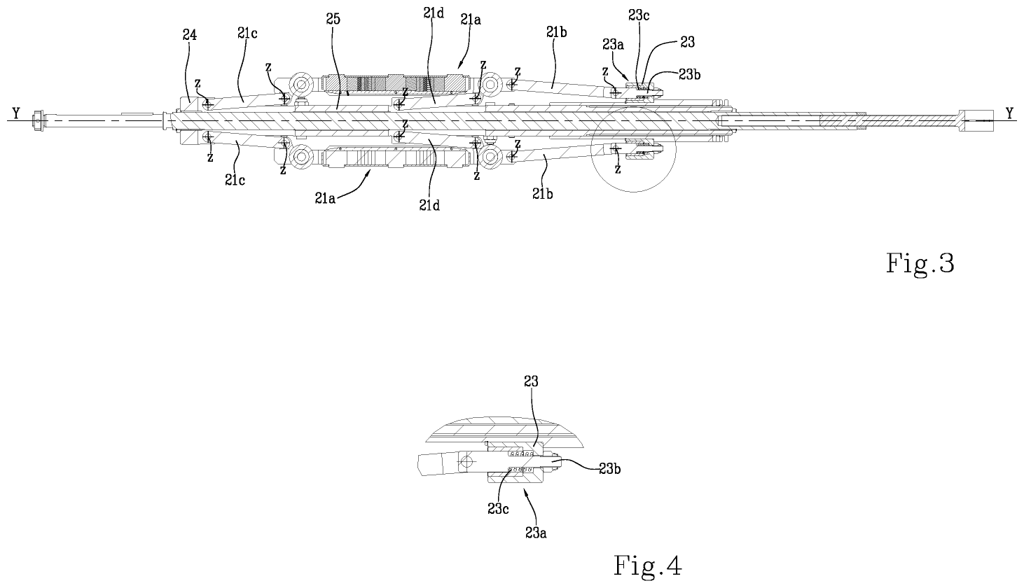

FIG. 3 shows a sectional view of the component of FIG. 1, on a plane containing a longitudinal axis (Y);

FIG. 4 shows an enlargement of FIG. 3;

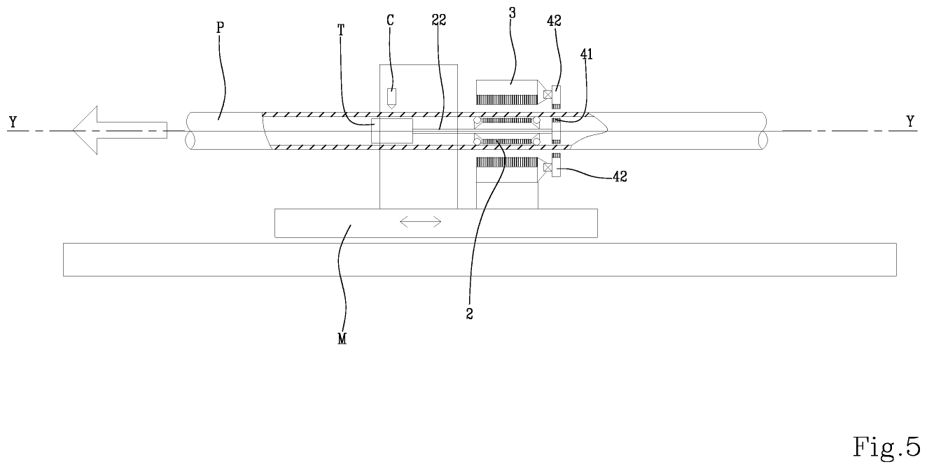

FIG. 5 schematically shows the drawing device according to the present invention, combined with a cutting unit of a profiling line;

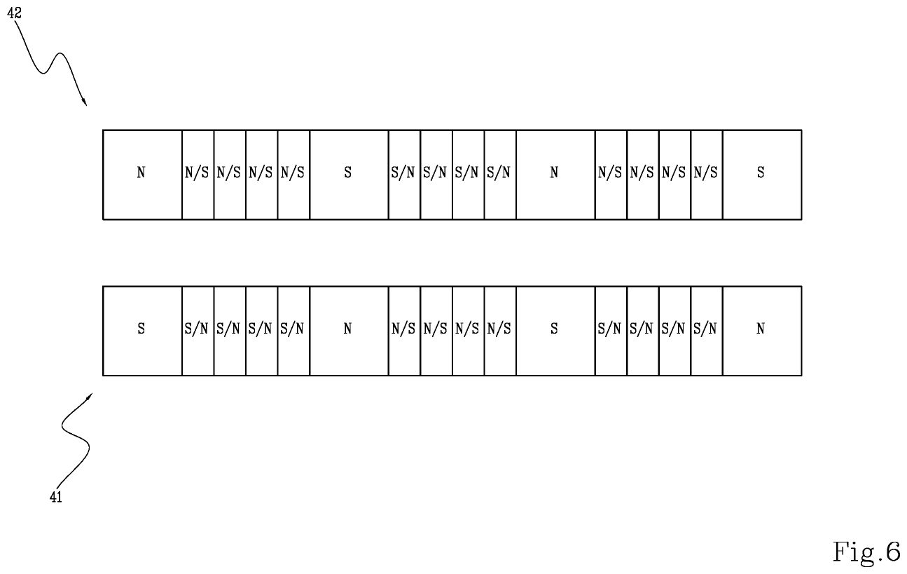

FIG. 6 shows an advantageous configuration of an element of the invention.

The drawing device for drawing a tool (T) according to the present invention comprises a support (2), provided with rests (21), structured to be slidably arranged in contact with an inner wall of a tube, and an attachment (22) for a tool (T). The device further comprises a cursor (3), movable along a longitudinal direction (Y) between at least a starting position and a return position. Magnetic means (4) is predisposed to magnetically constrain the support (2) and the cursor (3) with respect to the displacement along the longitudinal direction (Y).

In essence, by virtue of the presence of magnetic means (4), the support (2), and the tool (T) associated thereto, can be drawn by the cursor (3) inside the tube, along the longitudinal direction (Y), without the need to predispose direct mechanical connections between the support (2) and the cursor (3), nor between the support (2) and a motor means or other structure outside the tube.

In other words, the support (2) can be placed inside the tube and interact with the cursor (3) without the need for further connections in addition to the rests (21) and the magnetic means (4). In particular, the support (2), for translating along the longitudinal direction (Y) and/or for rotating about the longitudinal direction (Y), is not provided and/or is not connected to other motors in addition to the cursor (3).

This is particularly advantageous in the production lines of longitudinally welded tubes, widely known in the sector, since the cursor (3) and the support (2), by virtue of the presence of the magnetic means (4), can be placed substantially in any zone or position of the line, so that the tool (T), associated to the support (2), can operate inside the tube.

In the preferred but not exclusive embodiment shown, the support (2) comprises four rests (21), arranged in angular positions offset by 90° about the longitudinal axis (Y). However, only two or three rests (21) can be predisposed, to allow a prefixed radial positioning of the support (2) with respect to the longitudinal axis (Y). In a possible embodiment, not illustrated, the support (2) could comprise a cylindrical structure of non-adjustable diameter, in place of the rests (21). Such a solution is particularly cost-effective, for example, in the case of processing tubes of small diameter, without the need for frequent format changes.

Each rest (21) is movable along a radial direction with respect to the longitudinal axis (Y), to allow the adjustment of the radial position of the support (2) with respect to the longitudinal axis (Y).

To this end, in the embodiment shown, each rest (21) comprises an articulated arm (21a,21b,21c), movable on a radial plane with respect to the longitudinal axis (Y). The articulated arm comprises a central portion (21a) structured so as to be arranged parallel to the longitudinal axis (Y). Such a central portion (21a) is intended to be positioned in contact with the inner surface of the tube. Preferably, the central portion has an elongated shape parallel to the longitudinal axis (Y).

The central portion (21a) is movable, on the radial movement plane of the articulated arm, along a radial direction with respect to the longitudinal axis (Y). To this end, each articulated arm comprises a first portion (21b) and a second portion (21c). The first portion (21b) is pivoted to the central portion (21a) and to a first collar (23) about two axes (Z) perpendicular to the longitudinal axis (Y) and the radial displacement plane of the central portion (21a). The second portion (21c) is pivoted to the central portion (21a) and to a second collar (24) about two axes (Z) parallel to the preceding ones.

The first and the second collar (23,24) are concentric to the longitudinal axis (Y) and are movable with respect to one another along the longitudinal axis (Y). By bringing the collars (23,24) closer together and farther apart, it is therefore possible to move the central portion (21a) away from and closer with respect to the longitudinal axis (Y), respectively.

The collars (23,24) are slidable on a main body (25) of the support (2). Such a main body (25) is associated to the attachment (22) for the tool (T). In the embodiment depicted, the attachment (22) is supported by a rod protruding from one end of the main body (25), concentrically or parallel to the longitudinal axis (Y). The rod and/or the attachment (22) are provided with adjustment means, known in the art and not illustrated in detail, to allow the position of the tool (T) to be varied along the longitudinal axis (Y) with respect to the main body (25).

To maintain the central portion (21a) parallel to the longitudinal axis (Y), each rest (21) comprises a connecting rod (21d), pivoted about axes parallel to the transverse direction (Z), the support (2) and the central portion (21a).

Preferably, but not necessarily, the first portion (21b) and/or the second portion (21c) are pivoted to the respective collar (23,24) by means of a constraint (23a) elastically slidable in a direction parallel to the longitudinal axis (Y). This allows the central portion (21a) a limited elastic extension movement along a radial direction with respect to the longitudinal axis (Y). In the embodiment depicted, the first portion (21b), at a first end (211b), is pivoted on a constraint (23a) which comprises a stem (23b) slidable in a direction parallel to the longitudinal axis (Y) within a seat solidly constrained to the first collar (23). An elastic element (23c), for example a helical spring, is interposed between two shoulders, obtained respectively in the seat and on the stem (23b), to push the stem (23b) towards the first portion (21b). A stop element (23d), for example a nut, is associated to the stem (23b) to prevent the latter from completely removing from the seat, disengaging from the first collar (23).

The magnetic means (4) comprises at least one magnet and/or a ferromagnetic body (41) solidly constrained to the support (2). The magnetic means further comprises at least one magnet and/or a ferromagnetic body (42) solidly constrained to the cursor (3).

In essence, the magnetic means (4) can comprise magnets (41,42), respectively associated to the support (2) and the cursor (3), or a magnet and a ferromagnetic element, respectively associated to the support (2) and the cursor (3), or vice versa.

As already mentioned, the magnetic means (4) is arranged so as to produce an attraction which makes the support (2) and the cursor (3) solidly constrained at least with respect to the translation along the longitudinal axis (Y).

In the embodiment depicted, preferred but not exclusive, the magnetic means (4) comprises at least one first magnetic element (42), solidly constrained to the cursor (3), and at least one second magnetic element (41), solidly constrained to the support (2). In particular, the magnetic means comprises four magnetic elements (42), arranged at 90° angular steps about the longitudinal axis (Y) and alternating with each other with inverted North-South polarity. Each magnetic element (42) is associated to a support (43), associated to the cursor (3) and movable along a radial direction with respect to the longitudinal axis (Y). The magnetic elements (42) solidly constrained to the cursor (3) interact with respective magnetic elements (41), solidly constrained to the support (2). In particular, the magnetic elements (41) are solidly constrained to the central portion (21a) of the articulated arms (21). Thereby, the magnetic elements (41) are located at the minimum distance from the wall of the tube, i.e., at the minimum distance from the magnetic elements (42) solidly constrained to the cursor (3).

In an advantageous embodiment, schematised in FIG. 6, each magnetic element (41,42) comprises a series of magnets (41a,42a) aligned along the longitudinal axis (Y) and comprised between two ferromagnetic expansions (41b,42b). The magnets (41a,42a) of each series are arranged with the polarities oriented in the same manner with respect to the longitudinal axis (Y), i.e., S-N or N-S. Thereby, the two expansions (41b,42b) arranged at the ends of a respective series of magnets are subject to opposite polarities, as illustrated in FIG. 6. By distributing the magnets (41a,42a) in a mirrored manner in the two magnetic elements (41,42), it is possible to obtain ferromagnetic expansions of opposite polarity, and thus an attractive force between the two ferromagnetic elements. Furthermore, each magnetic element (41,42) may comprise a greater number of series of magnets (41a,42a), separated from each other by ferromagnetic expansions (41b,42b) of inverted polarity along the longitudinal axis (Y), according to the scheme described above and illustrated in FIG. 6.

Obviously, several further positionings of the magnetic means (4) are possible. Furthermore, the magnetic means (4), positioned as described above, could comprise magnets and ferromagnetic elements, in place of a part of the magnets (41,42).

Advantageously, but not necessarily, the cursor (3) is rotatable about the longitudinal axis (Y). The rotation of the cursor (3) can be achieved by motor means known to those skilled in the art.

The rotation of the cursor (3) allows the tool (T) to be rotated, through the rotation of the support (2). In fact, the attraction exerted by the magnetic means (4) between the cursor (3) and the support (2) allows to transmit the rotation of the cursor (3) to the support (2).

In the embodiment depicted, the cursor (3) comprises a frame (31), structured to be positioned outside a tube. In the embodiment shown, the frame (31) has a tubular shape, so as to be arranged about the tube, concentrically to the longitudinal axis (Y). In an alternative solution, the frame (31) could have a non-tubular configuration, for example it could consist of two or more portions connected together in various modes.

Each magnet or ferromagnetic element (42) of the cursor (3) is associated to a support (43), in turn slidingly connected to the frame (31) along a radial direction with respect to the longitudinal axis (Y). This allows the radial position of each magnet or ferromagnetic element (42) to be adjusted in relation to the dimensions of the tube.

The tool (T), which can be associated with the attachment (22) of the support (2), comprises, for example, a container (T) provided with at least one opening facing radially with respect to the longitudinal axis (Y). The container (T) can be used to collect scrap produced by an orbital cut, in particular performed by means of a laser beam. To this end, the container (T) can be positioned inside the tube, at the section on which the orbital cutting is performed by means of a cutting unit (C) provided with a cutting head known to those skilled in the art. A head for the orbital cutting of tubular profiles is described for example in EP2881215.

In cutting operations involving the rotation of the cutting head, the container (T) can be driven in rotation to substantially follow the rotation of the cutting head and collect the scraps which are projected inside the tube. In cutting operations not involving the rotation of the cutting head, it is obviously not necessary for the container (T) to rotate.

The drawing device according to the present invention is particularly suited to be used in a machine for the dynamic orbital cutting of tubes.

A machine of this type, known in the art, comprises a main carriage (M), movable along a longitudinal axis (Y) of a tube between at least a starting position and a return position. The main carriage (M) supports a cutting unit (C), predisposed to realise an orbital cut of the tube, in a prefixed position. The cutting unit (C) is predisposed to receive a tube, coming from the production line, and to cut the tube according to a plane transverse or perpendicular to the longitudinal axis Y, in particular according to a vertical plane, in order to obtain a piece of tube separated from the remaining part of the tube.

The cutting unit (C) is predisposed to realise an orbital cut, i.e., a cut realised on the tube wall. To this end, the cutting unit (C) comprises one or more cutting tools (not illustrated as known per se) movable along a circular trajectory or curve which extends about the longitudinal axis (Y) of the tube. Cutting tools may consist of laser units, or units for cutting by water, plasma or by mechanical removal of material, for example by means of circular rotating blades. In any case, the cutting tools are movable in revolution about the longitudinal axis (Y) of the tube and approaching and moving radially away with respect to the tube itself.

The cutting unit (C) cuts the tube according to a cutting line resting on a transverse plane, substantially perpendicular to the longitudinal axis (Y) of the tube. Such a plane is preferably vertical.

By means of the main carriage (M), the cutting unit (C) is movable along a direction parallel to the longitudinal axis (Y), to operate with tracking technique on the tube. That is, the cutting unit (C) is movable, by means of the main carriage, parallel to the longitudinal axis (Y) of the tube. In particular, the main carriage (M), and the cutting unit (C) associated therewith, are movable forwards and backwards with respect to the tube, in turn movable forwards along the production line. During the forward stroke of the main carriage, the cutting unit (C) may move at the same advancement speed as the tube, at least for a time sufficient to complete the cutting of the tube and, subsequently, may be brought backwards to operate a new cut on a subsequent part of the tube. The above can be summarised by saying that the cutting unit (C) is movable forwards and backwards between a starting position, further upstream with respect to the advancement direction of the tube, which corresponds to a starting position of the forward stroke during which the tube is cut, and a return position, further downstream with respect to the advancement direction of the tube, during which the cutting unit (C) returns to the starting position without interacting with the tube.

Advantageously, the drawing device according to the present invention is associated to the main carriage (M), so as to translate solidly constrained to the cutting unit (C). Preferably, the cursor (3) is associated to the main carriage (M), and the support (2) is positioned so that the attachment (22) carries the tool (T), in the form of a container, at the action plane of the cutting tools. Preferably, the cursor (3) is movable with respect to the main carriage (M), to allow the adjustment of the position of the support (2) and the tool (T) with respect to the cutting unit (C).

By virtue of the use of the magnetic means (4) to bind the support (2) and the cursor (3) together, the drawing device according to the present invention can therefore be arranged simply on board the main carriage (M) of the cutting machine, without requiring particular and complex support structures of the type currently used. Furthermore, the magnetic connection implemented by the magnetic means (4) between the support (2) and the cursor (3), allows the free sliding of the tube with respect to the main carriage (M), for performing the cutting cycle described above.

1. A drawing device for drawing a tool (T), characterised in that it comprises: a support (2), provided with rests (21), structured to be slidably arranged in contact with an inner wall of a tube, and an attachment (22) for a tool (T); a cursor (3), movable along a longitudinal direction (Y) between at least a starting position and a return position; magnetic means (4), predisposed to magnetically constrain the support (2) and the cursor (3) with respect to the displacement along the longitudinal direction (Y).

2. The device according to claim 1, wherein each rest (21) is movable along a radial direction with respect to the longitudinal axis (Y).

3. The device according to claim 2, wherein each rest (21) comprises an articulated arm (21a, b . . . ) provided with a central portion (21a) structured so as to be arranged parallel to the longitudinal axis (Y).

4. The device according to claim 3, wherein:
each articulated arm comprises a first portion (21b) and a second portion (21c);
the first portion (21b) is pivoted, about two distinct parallel axes, to the central portion (21a) and to a first collar (23);
the second portion (21c) is pivoted, about two distinct parallel axes, to the central portion (21a) and to a second collar (24);
the first and the second collar (23, 24) are movable with respect to one another along the longitudinal axis (Y).

5. The device according to claim 4, wherein the first portion (21b) and/or the second portion (21c) are pivoted to the respective collar (23, 24) by means of a constraint (23a, 24a) that is elastically slidable in a parallel direction to the longitudinal axis (Y).

6. The device according to claim 4, wherein each rest (21) comprises a connecting rod (21d) pivoted, about distinct parallel axes, to the support (2) and to the central portion (21a).

7. The device according to claim 1, wherein the magnetic means (4) comprise at least one magnetic element (41) solidly constrained to a rest (21).

8. The device according to claim 1, wherein the magnetic means (4) comprise at least one magnetic element (42) solidly constrained to the cursor (3).

9. The device according to claim 8, wherein each magnetic element (42) is associated to a movable support (43) along a radial direction with respect to the longitudinal axis (Y).

10. The device according to claim 1, wherein the tool (T) comprises a container provided with at least one opening facing radially with respect to the longitudinal axis (Y).

11. The device according to claim 1, wherein the cursor (3) comprises a frame (31), structured so as to be positioned outside a tube.

12. The device according to claim 1, wherein the cursor (3) is rotatable about the longitudinal axis (Y).

13. A dynamic orbital cutting machine for tubes, comprising: a main carriage (M), movable along a longitudinal axis (Y) of a tube between at least a starting position and a return position; a cutting unit (C), predisposed to realise an orbital cut of the tube, in a prefixed position; characterised in that it comprises a drawing device according to claim 1, wherein the cursor (3) is associated to the main carriage (M).

14. The machine according to claim 13, wherein the tool (T) associated to the support (2) is predisposed to remain in a predetermined position with respect to the cutting unit (C).

15. The machine according to claim 14, wherein the cursor (3) is movable with respect to the main carriage (M), in order to enable adjustment of the position of the tool (T) with respect to the cutting unit (C).
